(19) United States
(12) Patent Application Publication
(10) Pub. No.: US 2025/0060588 A1
(43) Pub. Date: Feb. 20, 2025

(54) DISPLAY SYSTEM FOR PROVIDING HIGH CONTRAST RATIO AND REDUCING RAINBOW EFFECT

(71) Applicant: Meta Platforms Technologies, LLC, Menlo Park, CA (US)

(72) Inventors: Hyunmin SONG, Redmond, WA (US); Min Hyuk CHOI, San Jose, CA (US); Yun-Han LEE, Redmond, WA (US); Michael ESCUTI, Redmond, WA (US); Zhiming ZHUANG, Sammamish, WA (US)

(21) Appl. No.: 18/776,525

(22) Filed: Jul. 18, 2024

Related U.S. Application Data
(60) Provisional application No. 63/520,606, filed on Aug. 18, 2023.

(51) Int. Cl. G02B 27/01

(52) U.S. Cl. CPC G02B 27/0103; G02B 2027/0118

(57) ABSTRACT

A system includes a display element configured to output an image light. The system also includes an image combiner configured to guide the image light toward an eye-box region of the system. The system also includes a dimming device disposed at a side of the image combiner. The dimming device includes a dimming material layer including a mixture of liquid crystal (“LC”) molecules and dye molecules, and pretilt angles of the LC molecules and the dye molecules are configured with a predetermined variation in at least two opposite in-plane directions from a center to two opposite peripheries of the dimming material layer.

### CROSS REFERENCE TO RELATED APPLICATION

This application claims the benefit of priority to U.S. Provisional Application No. 63/520,606, filed on Aug. 18, 2023. The content of the above-referenced application is incorporated by reference in its entirety.

### TECHNICAL FIELD

The present disclosure relates generally to optical devices and, more specifically, to a display system for providing a high contrast ratio and reducing a rainbow effect.

### BACKGROUND

An artificial reality system, such as a head-mounted display (“HMD”) or heads-up display (“HUD”) system, generally includes a near-eye display (“NED”) system in the form of a headset or a pair of glasses, and configured to present content to a user via an electronic or optic display within, for example, about 10-20 mm in front of the eyes of a user. The NED system may display virtual objects or combine images of real objects with virtual objects, as in VR, AR, or MR applications. For example, in an AR or MR system, a user may view both images of virtual objects (e.g., computer-generated images (“CGIs”)) and real objects in the surrounding real-world environment by, for example, seeing through transparent display glasses or lenses.

An AR system may include a pupil-expansion waveguide display system, in which an image light representing a CGI may be coupled into a waveguide, propagate within the waveguide via totally internal reflection, and be coupled out of the waveguide at different locations to expand an effective pupil. The waveguide may also combine the image light representing the CGI and a light from the real-world environment, such that the virtual image may be superimposed with real-world images.

### SUMMARY OF THE DISCLOSURE

According to an aspect of the present disclosure, a system is provided. The system includes a display element configured to output an image light. The system also includes an image combiner configured to guide the image light toward an eye-box region of the system. The system also includes a dimming device disposed at a side of the image combiner. The dimming device includes a dimming material layer including a mixture of liquid crystal (“LC”) molecules and dye molecules, and pretilt angles of the LC molecules and the dye molecules are configured with a predetermined variation in at least two opposite in-plane directions from a center to two opposite peripheries of the dimming material layer.

Other aspects of the present disclosure can be understood by those skilled in the art in light of the description, the claims, and the drawings of the present disclosure. The foregoing general description and the following detailed description are exemplary and explanatory and are not restrictive of the claims.

### BRIEF DESCRIPTION OF THE DRAWINGS

The following drawings are provided for illustrative purposes according to various disclosed aspects and are not intended to limit the scope of the present disclosure. In the drawings:

FIGS. 1A and 1B illustrate schematic views of a display system configured to provide a high contrast ratio and reduce a rainbow effect, according to one or more examples of the present disclosure;

FIG. 1C illustrates a schematic view of a display system configured to provide a high contrast ratio and reduce a rainbow effect, according to one or more examples of the present disclosure;

FIG. 2A illustrates a schematic view of an active dimming device operating at a voltage-off state, according to one or more examples of the present disclosure;

FIG. 2B illustrates a schematic view of an active dimming device operating at a voltage-on state, according to one or more examples of the present disclosure;

FIG. 2C illustrates a schematic view of a passive dimming device, according to one or more examples of the present disclosure;

FIG. 2D illustrates a schematic view of a dimming material layer that may be included in a dimming device disclosed herein, according to one or more examples of the present disclosure;

FIGS. 3A and 3B illustrate schematic views of a display system configured to provide a high contrast ratio and reduce a rainbow effect, according to one or more examples of the present disclosure;

FIG. 4A schematically illustrates a diagram of an artificial reality device, according to one or more examples of the present disclosure; and

FIG. 4B schematically illustrates a cross-sectional view of half of the artificial reality device shown in FIG. 4A, according to one or more examples of the present disclosure.

### DETAILED DESCRIPTION

The present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. The sequence in which the plurality of optical elements are arranged may or may not affect an overall output of the plurality of optical elements. A coupling may be a direct coupling or an indirect coupling (e.g., coupling through an intermediate element).

The phrase “one or more” may be interpreted as “at least one.” The phrase “at least one of A or B” may encompass various combinations of A and B, such as A only, B only, or A and B. Likewise, the phrase “at least one of A, B, or C” may encompass various combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass various combinations of A and B, such as A only, B only, or A and B. Likewise, the phrase “A, B, and/or C” has a meaning similar to that of the phrase “at least one of A, B, or C.” For example, the phrase “A, B, and/or C” may encompass various combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

A conventional light guide (or waveguide) display system may include a light source assembly configured to emit an image light representing a virtual image, and a light guide (or waveguide) configured to guide the image light to an eye-box region. The light guide may be coupled with a plurality of couplers configured to couple the image light into the light guide and out of the light guide toward the eye-box region. The couplers used in a geometric light guide display system may include partially reflective couplers, whereas the couplers used in a diffractive light guide display system may include gratings. The light guide may also receive a visible polychromatic light coming from a real-world environment (referred to as a real-world light). The real-world light incident onto the light guide at an incidence angle within a range of large incidence angles (referred to as a large incidence angle range) may also be coupled into the light guide. The couplers may diffract, refract, and/or reflect the real-world light of a large incidence angle, which may cause a multicolored glare in a see-through view, especially when a user wearing the artificial reality device looks at a bright light source. Such a see-through artifact is referred to as a rainbow effect or a world side ghost, which may degrade the image quality of the see-through view. The rainbow effect may result from a light dispersion caused by the coupler, as the coupler spatially separates, e.g., via diffraction, reflection, and/or refraction, the real-world light into component lights corresponding to constituent wavelength components. Component lights corresponding to different wavelength components of the incident light spectrum may be directed to different directions, thereby generating a rainbow of colors under a white light illumination. A conventional light guide display system often suffer from two major issues for augmented reality (“AR”) and/or mixed reality (“MR”) applications: the appearance of a rainbow effect resulting from an ambient light incident onto a light guide at a large angle of incidence (“AOI”) or incidence angle, and a low indoor or outdoor contrast ratio due to an ambient light competing against an image light that represents a virtual image.

The present disclosure provides a dimming device and a display system including the dimming device. The display system implemented with the dimming device may be configured to reduce the rainbow effect and increase the contrast ratio. The display system disclosed herein may be implemented in an artificial reality device for AR and/or MR applications. The display system disclosed herein may be a light guide (or waveguide) based display system, a holographic optical element (“HOE”) based display system, a freeform optics-based display system, a metasurface-based display system, or a pinlight based display system, etc. In the following, a light guide display system and an HOE based display system are used as examples for explaining the implementation of a disclosed dimming device into a display system included in an artificial reality device.

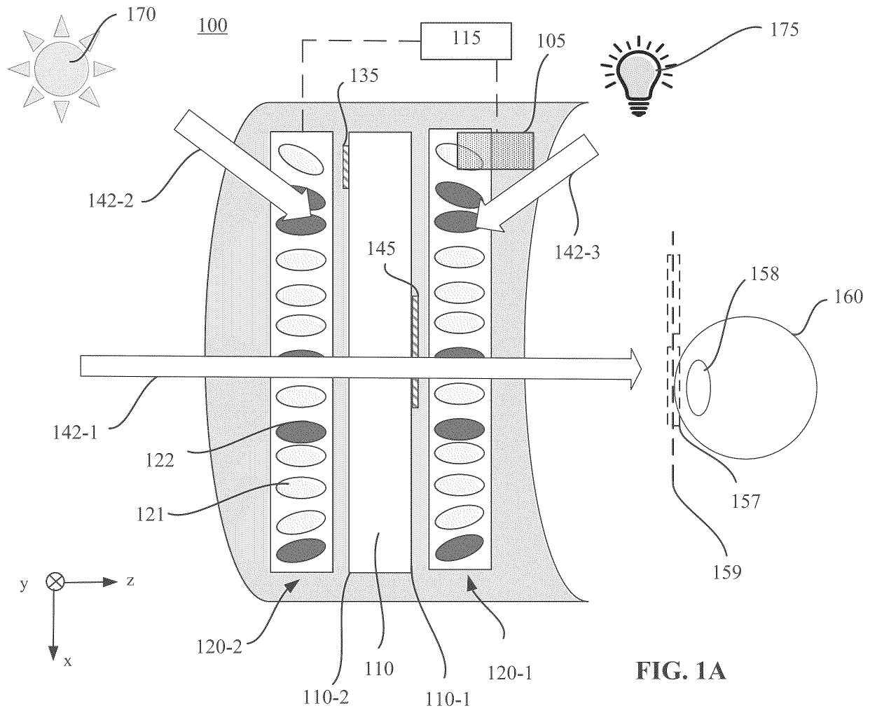

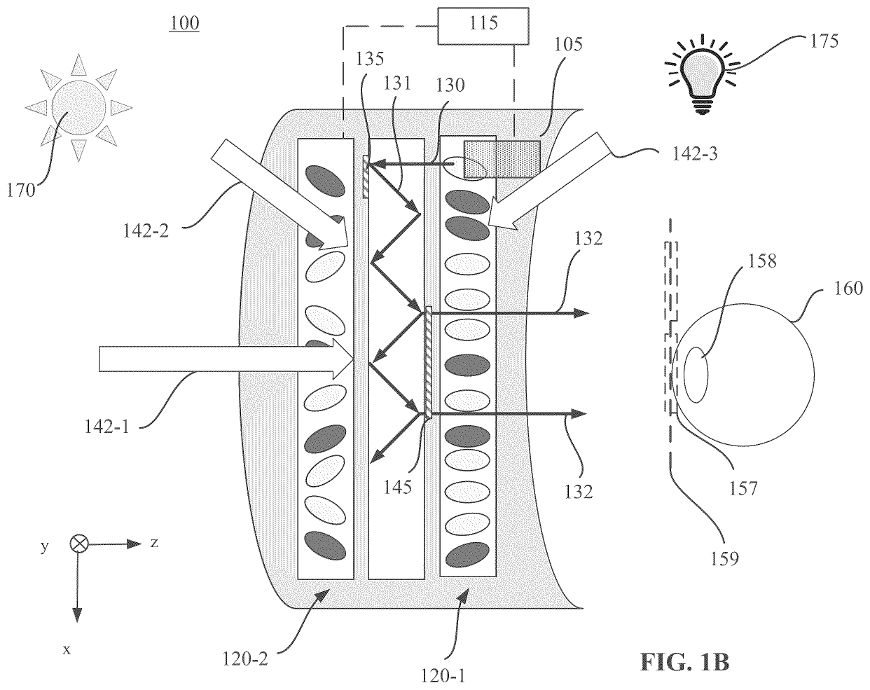

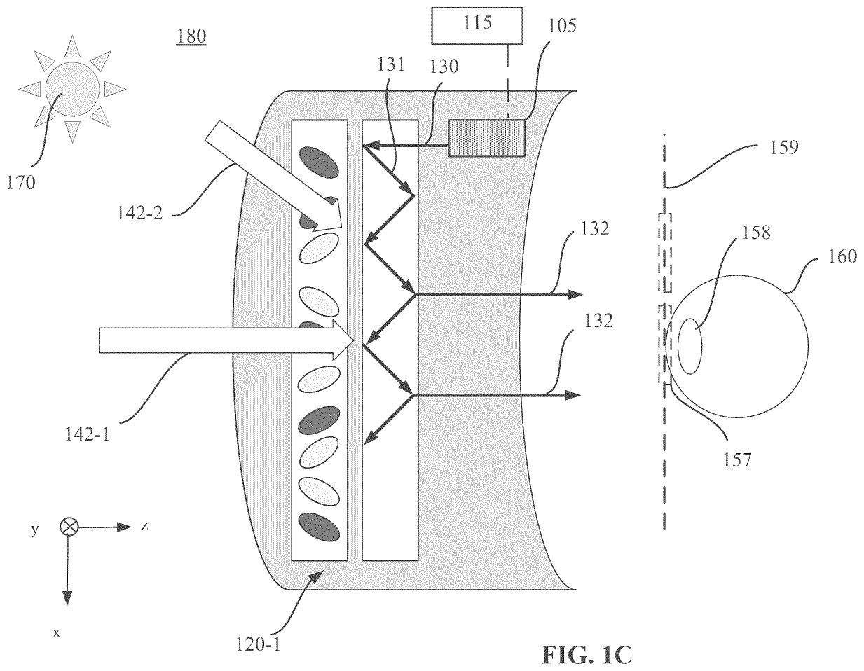

FIGS. 1A and 1B illustrate x-z sectional views of a display system 100 configured to reduce the rainbow effect and increase the contrast ratio, according to one or more examples of the present disclosure. The display system 100 may be a suitable light guide (or waveguide) display system, such as a geometric light guide display system including one or more refractive and/or reflective type couplers, a diffractive light guide display system including one or more diffractive type couplers, a mixed light guide display system including one or more refractive and/or reflective type couplers and one or more diffractive type couplers. As shown in FIGS. 1A and 1B, the system 100 may include a light source assembly 105, a light guide (or waveguide) 110, a controller 115, and two dimming devices 120-1 and 120-2 (collectively referred to as dimming device(s) 120) coupled with the light guide 110. The controller 115 may be communicatively coupled with various elements in the system 100, such as, for example, the light source assembly 105 and the dimming devices 120, to control the operation thereof.

The light source assembly 105 may be configured to emit an image light (referred to as an input image light) 130 representing a virtual image toward the light guide 110. For example, the light source assembly 105 may include a display element (e.g., a micro projector) configured to emit an image light, and a collimating lens configured to collimate the image light received from the display element into the input image light 130 having an input field of view (“FOV”). The system 100 may also include a plurality of couplers, including an in-coupler 135 (also referred to as an input coupler or an in-coupling element) and an out-coupler 145 (also referred to as an output coupler or an out-coupling element). The in-coupler 135 may be configured to couple the image light 130 into the light guide 110. The out-coupler 145 may be configured to couple the image light 130 out of the light guide 110 toward an eye-box region 159 of the system 100. The couplers 135 and 145 may be disposed at one or more surfaces of the light guide 110, or may be embedded inside the light guide 110. One or more (e.g., in some examples, each) of the couplers 135 and 145 may include one or more diffractive optical elements (e.g., gratings), one or more refractive optical elements (e.g., prisms), or one or more refractive optical elements (e.g., mirrors), etc. The light guide 110 including the couplers 135 and 145 may also be referred to as an image combiner or an optical combiner.

The light guide 110 may have a first side 110-1 (or first surface 110-1) facing the eye-box region 159 and a second side 110-2 (or second surface 110-2) opposite to the first side 110-1. In some examples, one or more (e.g., each) of the couplers 135 and 145 may be formed or disposed at (e.g., affixed to) the first surface 110-1 or the second surface 110-2 of the light guide 110. In some examples, one or more (e.g., each) of the couplers 135 and 145 may be integrally formed as a part of the light guide 110, or may be a separate element coupled to the surfaces of the light guide 110. For discussion purposes, FIG. 1A shows the couplers 135 and 145 are disposed at the first side 110-1 and the second side 110-2 of the light guide 110, respectively. The in-coupler 135 may also be referred to as an in-coupling element (or input coupler) 135, which may couple the image light 130 into the light guide 110 as an in-coupled image light 131. The in-coupled image light 131 may propagate inside the light guide 110 via total internal reflection (“TIR”).

The out-coupler 145 may also be referred to as an out-coupling element (or output coupler), which may couple the in-coupled image light 131 out of the light guide 110 as one or more output image lights 132 propagating toward one or more exit pupils 157 located in the eye-box region 159. The output image light 132 may have an output FOV associated with an FOV of the system 100. The FOV of the system 100 refers to the angles or extent of the viewable space of the system 100, in which the virtual content represented by the output image light 132 is visible to the user. The exit pupil 157 may correspond to a spatial zone where an eye pupil 158 of an eye 160 of the user may be positioned in the eye-box region 159 of the system 100 to perceive the virtual image represented by the image light 130.

The system 100 may provide a one-dimensional pupil expansion. For example, FIG. 1B shows that the out-coupling element 145 expands the input image light 130 at the output side of the light guide 110, thereby expanding an effective pupil of the system 100 along an x-axis direction as shown in FIG. 1B. In some examples, the system 100 may provide a two-dimensional pupil expansion, expanding the pupil along both the x-axis direction and the y-axis direction shown in FIG. 1B. For example, the redirecting coupler may also be referred to as a folding coupler, a folding element, or a redirecting element, and may be configured to receive the in-coupled image light 131 from the in-coupling element 135, and direct the in-coupled image light 131 toward the out-coupling element 145. The redirecting element (not shown) may be configured to expand the input image light 130 along a first direction (e.g., the y-axis direction shown in FIG. 1B), and the out-coupling element 145 may be configured to expand the image light 130 along a second direction (e.g., the x-axis direction shown in FIG. 1B). Together, the redirecting element and the out-coupling element 145 may expand the image light 130 in two dimensions (referred to as a 2D expansion). In some examples, multiple functions, e.g., redirecting, folding, and/or expanding the image light 130 may be combined into a single element, e.g., the out-coupling element 145. For example, the out-coupling element 145 itself may be configured to provide a 2D expansion of the effective pupil of the system 100. For example, the out-coupling element 145 may be a 2D grating including a single grating layer or a single layer of diffractive structure.

The first dimming device 120-1 and the second dimming device 120-2 may be disposed at the first side 110-1 and the second side 110-2 of the light guide 110, respectively. The dimming devices 120 may be spaced apart from the light guide 110. In some examples, a low refractive index material may be disposed between each of the dimming devices 120 and the light guide 110, thereby enabling the propagation of the in-coupled image light 131 inside the light guide 110 via TIR. In some examples, the dimming devices 120 may be directly in contact with the light guide 110 without a gap therebetween, and may have a lower refractive index than the material of the light guide 110. In some examples, one or more (e.g., each) of the dimming devices 120 may be a global dimming device configured with a light transmittance that is uniform over substantially the entire aperture of the dimming device. In other words, one or more (e.g., each) of the dimming devices 120 may be configured to uniformly dim or attenuate an ambident light (or a real-world light) over substantially the entire aperture of the dimming device 120.

In some examples, one or more (e.g., each) of the dimming devices 120 may be a regional or local dimming lens configured to provide different light transmittances at different regions (or areas) of the aperture of the dimming device 120. The light transmittances at the respective regions or portions of the dimming device 120 for the ambident light may be individually or independently controllable. In some examples, one or more regions or areas (e.g., each region or area) of the apertures of one or more (e.g., each) of the dimming devices 120 may include one more pixelated dimming elements. The light transmittances at the respective pixelated dimming elements may be individually or independently controllable. In some examples, one or more (e.g., each) of the dimming devices 120 may be an active dimming element or a passive dimming device. An active dimming device may dynamically adjust the transmittance of the ambident light, and a passive dimming device may provide a substantially constant transmittance of the ambident light.

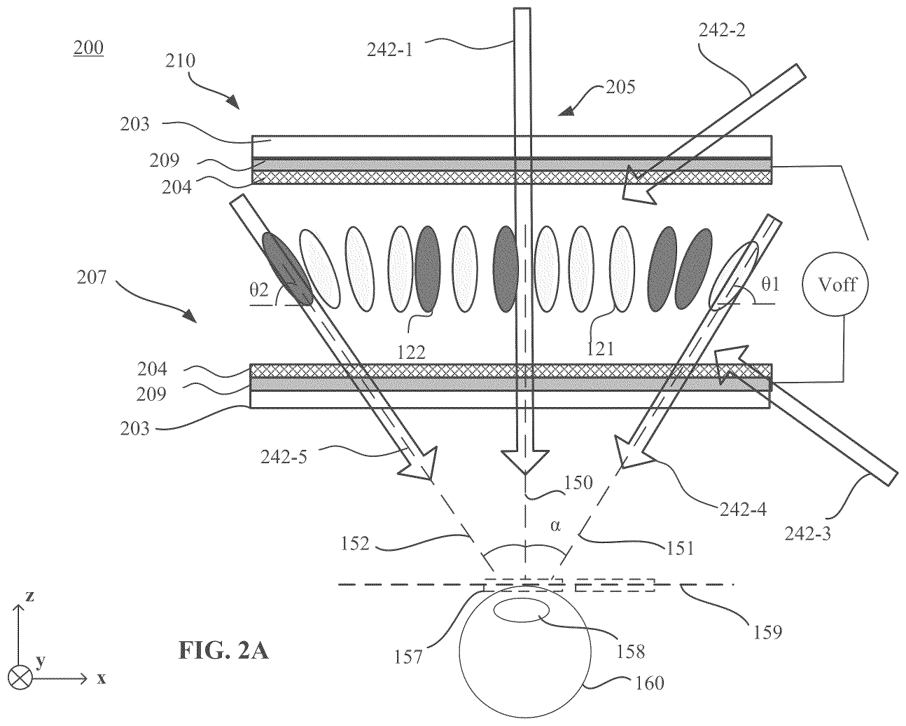

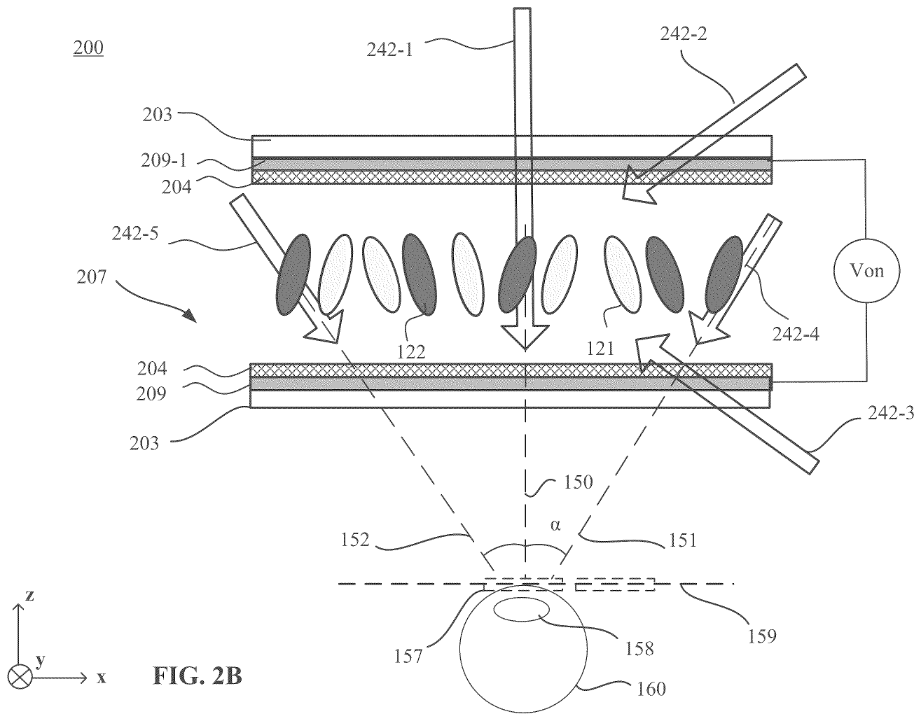

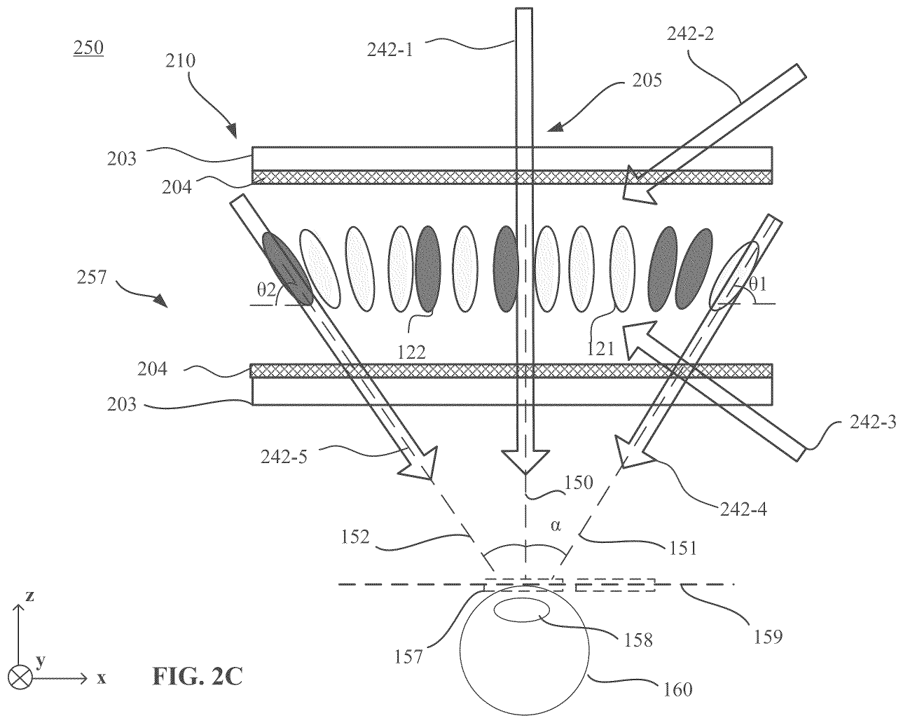

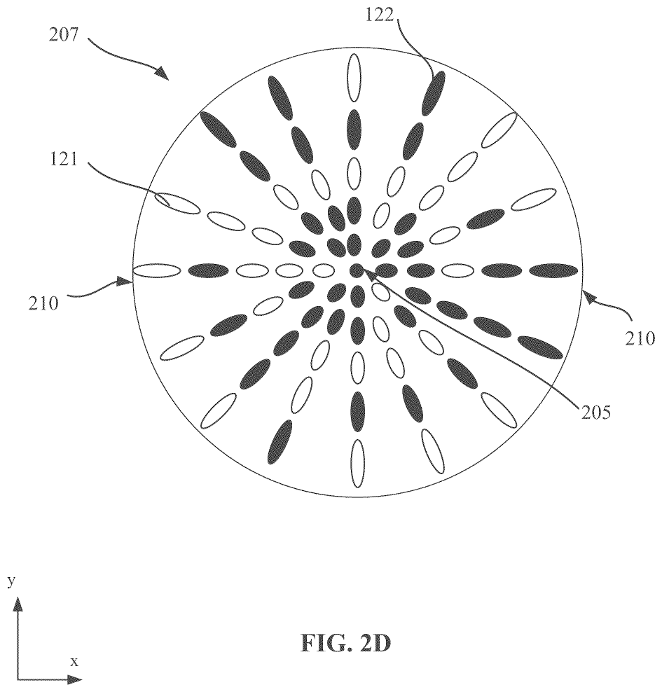

FIGS. 2A and 2B illustrate x-z sectional views of a dimming device 200, according to one or more examples of the present disclosure. The dimming device 200 may be an example of the dimming device 120 shown in FIGS. 1A and 1B. The dimming device 200 shown in FIGS. 2A and 2B may be an active dimming device configured to dynamically adjust the transmittance of an ambient light transmitting therethrough. FIG. 2A shows a voltage-off state of the dimming device 200, and FIG. 2B shows a voltage-on state of the dimming device 200.

As shown in FIG. 2A, the dimming device 200 may be a guest-host type LC dimming device. The dimming device 200 may include two substrates 203, two electrode layers (or electric conduction layers) 209, two alignment layers (or structures) 204, and a dimming material layer 207. The alignment layers 204 may be disposed at surfaces of respective substrates 203 that face one another, and the dimming material layer 207 may be disposed between the two alignment layers 204. The two electrode layers 209 may be disposed at surfaces of respective substrates 203 that face one another. Each electrode layer 209 may be disposed between a substrate 203 and an alignment layer 204 on each side of the dimming material layer 207. Although not shown, in some examples, the two electrode layers 209 may be disposed at a surface of a same substrate 203, i.e., on the same side of the dimming material layer 207. In some examples, one of the substrates 203 may be the light guide 110 shown in FIG. 1A. In some examples, one of the substrates 203 (e.g., the upper substrate 203) may have a curved shape. For example, when the dimming device 200 represents the second dimming device 120-2 shown in FIG. 1A, the lower substrate 203 of the dimming device 200 may be the light guide 110 shown in FIG. 1A, and the upper substrate 203 of the dimming device 200 may function as a prescription lens.

The dimming material layer 207 may be a guest-host LC layer that includes a mixture of host LCs 121 and guest dyes 122 doped into the LCs 121. In the configuration shown in FIG. 2A, the guest dyes 122 may include dichroic dyes that are voltage-responsive or electric-field-responsive dyes, and the guest-host LC layer may be a voltage-driven guest-host LC layer. For discussion purposes, the guest dyes 122 may also be referred to as the dichroic dyes 122. The LCs 121 in the dimming material layer 207 may have positive or negative dielectric anisotropy. The dichroic dyes 122 may have an anisotropic absorption. For example, the absorption properties of the dichroic dyes 122 may depend on a relative orientation between an absorption axis of the dichroic dyes 122 and a polarization direction of an incident light. The absorption axis of a positive dichroic dye may be along the long molecular axis of the positive dichroic dye, and absorption axis of a negative dichroic dye may be along the short molecular axis of the negative dichroic dye. For illustrative purposes, FIG. 2A shows the dichroic dyes 122 as positive dichroic dyes with the absorption axis being the long axis of the dye molecules 122.

The dichroic dyes 122 may relatively strongly absorb an incident light having a polarization direction that is parallel to an absorption axis of the dye molecules, and relatively weakly absorb the incident light having a polarization direction that is perpendicular to the absorption axis of the dye molecules. That is, the dichroic dyes 122 may provide a greater dimming effect to an incident light having a polarization direction parallel to the absorption axis of the dye molecules than to an incident light having a polarization direction perpendicular to the absorption axis of the dye molecules. Thus, through varying the orientation of the dye molecules of the dichroic dyes 122 via, e.g., an electric field, the transmittance of the incident light may be adjusted.

Molecules of the host LCs 121 (referred to as LC molecules 121) may be homeotropically aligned, and molecules of the guest dyes 122 (referred to as dye molecules 122) may be aligned together with the LC molecules 121 to have a perpendicular or homeotropic orientation. In the present disclosure, the orientations of the LC molecules 121 (that are the directions of the LC directors or long molecules axes) and the orientations of the dye molecules 122 (that are the directions of the long molecules axes) may be configured to vary in at least two opposite in-plane directions from a center 205 to opposite peripheries 210 of the dimming device 200 (or the dimming material layer 207), such that the FOV of the system 100 is not affected by the dimming device 200 disposed at the first side 110-1 of the light guide. For discussion purposes, the center 205 may also be referred to as an aperture center 205, and the periphery 210 may also be referred to as an aperture periphery 210.

In the present disclosure, the orientation of the LC molecule 121 may be defined by a tilt angle θ1 of the LC molecule 121, which is an angle of the LC director with respect to a surface of the dimming material layer 207. The tilt angle θ1 of the LC molecule 121 may be less than or equal to 90°. The tilt angle θ1 of the LC molecule 121 when the dimming device 200 operates at the voltage-off state may also be referred to as a pretilt angle of the LC molecule 121. The orientation of the dye molecule 122 may be defined by a tilt angle θ2 of the dye molecule 122, which is an angle of the long molecular axis with respect to the surface of the dimming material layer 207. The tilt angle θ2 of the dye molecule 122 may be less than or equal to 90°. The tilt angle θ2 of the dye molecule 122 when the dimming device 200 operates at the voltage-off state may also be referred to as a pretilt angle of the dye molecule 122. As the dye molecules 122 are aligned together with the LC molecules 121, the tilt angle (or pretilt angle) θ1 of the LC molecule 121 and the tilt angle (or pretilt angle) θ2 of the dye molecule 122 located at the same portion of the dimming material layer 207 may be substantially the same. For discussion purposes, the tilt angle (or pretilt angle) θ1 of the LC molecule 121 and the tilt angle (or pretilt angle) θ2 of the dye molecule 122 located at the same portion of the dimming material layer 207 may be collectively referred to as a tilt angle (or pretilt angle) θ.

As shown in FIG. 2A, when the dimming device 200 operates at the voltage-off state, the LC molecules 121 and the dye molecules 122 may be configured to have a predetermined pretilt angle variation in at least two opposite in-plane directions from the center 205 to the periphery 210 of the dimming device 200 (or the dimming material layer 207). FIG. 2D illustrates an x-y sectional view of the dimming material layer 207 shown in FIG. 2A. For discussion purposes, FIG. 2D shows that the dimming material layer 207 has a circular shape or a circular aperture. In some examples, although not shown, the dimming material layer 207 may have another suitable shape. Referring to FIG. 2A and FIG. 2D, the orientation of the LC molecules 121 and the dye molecules 122 may rotate in different rotation directions from the center 205 to the two opposite peripheries 210 of the dimming material layer 207. For example, as shown in FIG. 2A, from the center 205 to the right periphery 210 of the dimming material layer 207, the orientation of the LC molecules 121 and the dye molecules 122 may change in a clockwise direction. The changes in the orientations may form a clockwise rotation. From the center 205 to the left periphery 210 of the dimming material layer 207, the orientation of the LC molecules 121 and the dye molecules 122 may change in a counter-clockwise direction, and the changes in the orientations may form a counter-clockwise rotation. The pretilt angles θ of the LC molecules 121 and the dye molecules 122 may be configured to gradually decrease in at least two opposite in-plane directions (e.g., a plurality of opposite radial directions) from the center 205 to the periphery 210. Thus, the projections of the LC molecules 121 and the dye molecules 122 onto the surface of the dimming material layer 207 (e.g., an x-y plane) may gradually change from a circular shape at the center 205 to a rod like shape at the periphery 210, as shown in FIG. 2D.

When the eye 160 is presumed to be positioned substantially facing the center 205, the orientations of the LC molecules 121 and the dye molecules 122 at respective portions of the dimming device 200 may be configured in accordance with respective viewing directions (or gaze directions) of the eye 160 looking through the respective portions of the dimming device 200. For example, the LC molecules 121 and the dye molecules 122 at respective portions of the dimming device 200 may be oriented in respective viewing directions associated with the respective portion. That is, the orientation (or pretilt angles θ) of the LC molecules 121 and the dye molecules 122 may be configured to vary along with the viewing direction of the eye 160 looking through the dimming device 200.

The range of the viewing directions of the eye 160 may be associated with (e.g., substantially the same as) the FOV of the system 100, and the viewing directions of the eye 160 may correspond one-to-one with FOV directions of the system 100. For example, when the FOV of the system 100 is +30° to −30°, the range of the viewing directions may also be +30° to −30°. The leftmost FOV direction and the leftmost viewing direction may both be −30°, and the rightmost FOV direction and the rightmost viewing direction may both be +30°.

The viewing direction associated with a portion of the dimming device 200 may form an angle α with respect to a normal of the surface of the dimming material layer 207. The angle α may be defined as a positive angle or a negative angle, depending on the angular relationship between the viewing direction and the normal of the surface. For example, when the viewing direction deviates clockwise from the normal, the angle α between the viewing direction and the normal may be defined as a positive angle, and when the viewing direction deviates counter-clockwise from the normal, the angle α between the viewing direction and the normal may be defined as a negative angle. In some examples, the pretilt angle θ of the LC molecules 121 (and the dye molecules 122) and the absolute value of the angle α of the viewing direction at each portion of the dimming device 200 may be complementary angles.

For discussion purposes, FIG. 2A shows the variation of the pretilt angle θ in accordance with the viewing direction within the x-z plane. As shown in FIG. 2A, a viewing direction 150 associated with the center 205 may be parallel with the normal of the surface of the dimming material layer 207, and the angle α of the viewing direction 150 may be 0°. The viewing direction 150 may be referred to as a 0° viewing direction 150. The LC molecules 121 (and the dye molecules 122) located at the center 205 may be substantially oriented along the viewing direction 150, with the pretilt angle θ being about 90°.

A viewing direction 151 associated with the right periphery 210 may be tilted in a clockwise direction from the normal of the surface of the dimming material layer 207, and the angle α of the viewing direction 151 may have a positive value (e.g., +30°). The LC molecules 121 (and the dye molecules 122) located at the right periphery 210 may be substantially oriented along the viewing direction 151, e.g., with the pretilt angle θ1 being about 60°. From the center 205 to the right periphery 210, the pretilt angle θ of the LC molecules 121 (and the dye molecules 122) may gradually decrease from 90° to a predetermined value (e.g., about) 60°.

A viewing direction 152 associated with the left periphery 210 may be tilted in a counter-clockwise direction from the normal of the surface of the dimming material layer 207, and the angle α of the viewing direction 151 may have a negative value (e.g., −30°). The LC molecules 121 (and the dye molecules 122) located at the left periphery 210 may be substantially oriented along the viewing direction 152, e.g., with the pretilt angle θ2 being about 60°. From the center 205 to the left periphery 210, the pretilt angle θ of the LC molecules 121 (and the dye molecules 122) may gradually decrease from 90° to a predetermined value (e.g., about) 60°.

In some examples, the predetermined pretilt angle variation of the LC molecules 121 (and the dye molecules 122) may be configured through configuring the alignment layer 204. The alignment structure 204 may be a suitable alignment structure configured to at least partially align the LC molecules 121 (and the dye molecules 122) to have the predetermined pretilt angle variation. For example, the alignment structure 204 may include a nanostructure alignment layer, a polyimide layer, an alignment layer including a polyimide mixed with a liquid crystalline prepolymer, a hybrid alignment network, or any combination thereof.

In some examples, the alignment structure 204 may include a polyimide layer including a mixture of a planar polyimide and a vertical alignment polyimide. The planar alignment polyimide may align the LC molecules 121 in a range of relatively small pretilt angles (about 0° to about) 10°, whereas the vertical alignment polyimide may align the LC molecules 121 in a range of relatively large pretilt angles (e.g., about 85° to about) 90°. By configuring the mixture of the planar alignment polyimide and the vertical alignment polyimide (e.g., the concentration and distribution), the mixture may align the LC molecules 121 to have the predetermined pretilt angle variation. For example, a ratio of the vertical alignment polyimide over the planar alignment polyimide may be configured to gradually decrease along at least two opposite in-plane directions (e.g., a plurality of opposite radial directions) from a center to a periphery of the alignment structure 204 and, accordingly, the pretilt angle θ of the LC molecules 121 (and the dye molecules 122) may gradually decrease from 90° to a predetermined value (e.g., about) 60° in at least two opposite in-plane directions (e.g., a plurality of opposite radial directions) from the center 205 to the periphery 210.

In some examples, the alignment structure 204 may include a nanostructure alignment layer including a mixture of planar (or homogeneous or horizontal) polyimide domains and vertical (or homeotropic) alignment polyimide domains. By configuring the mixture of the horizontal polyimide domains and vertical alignment polyimide domains (e.g., the concentration and distribution), the mixture may align the LC molecules 121 to have the predetermined pretilt angle variation. For example, a ratio of the vertical alignment polyimide domains over the planar (or horizontal) polyimide domains may be configured to gradually decrease along at least two opposite in-plane directions (e.g., a plurality of opposite radial directions) from a center to a periphery of the alignment structure 204 and, accordingly, the pretilt angle θ of the LC molecules 121 (and the dye molecules 122) may gradually decrease from 90° to a predetermined value (e.g., about) 60° in at least two opposite in-plane directions (e.g., a plurality of opposite radial directions) from the center 205 to the periphery 210.

In some examples, the alignment structure 204 may include a photoalignment layer configured to align the LC molecules 121 (and the dye molecules 122) in the predetermined pretilt angle variation without a mechanical rubbing. The photoalignment layer may include a photoalignment material configured to provide a broad range of pretilt angles (e.g., about 1° to about) 89° depending on the irradiation dose (e.g., an ultra-violet (“UV”) irradiation dose) applied to the photoalignment material. The pretilt angle provided by the photoalignment material may increase as the irradiation dose increases. Through controlling the variation of the irradiation dose applied to the photoalignment material, the formed photoalignment layer may align the LC molecules 121 (and the dye molecules 122) with the predetermined pretilt angle variation.

In some examples, the alignment structure 204 may include an alignment layer including polyimide (e.g., vertical alignment polyimide or planar alignment polyimide) mixed with a liquid crystalline prepolymer. Through controlling the variation of the mixing ratio of the polyimide and liquid crystalline prepolymer, the formed alignment layer may align the LC molecules 121 (and the dye molecules 122) with the predetermined pretilt angle variation. When the mixing ratio of the polyimide and liquid crystalline prepolymer is fixed, through controlling the variation of the UV exposure time, the formed alignment layer may align the LC molecules 121 (and the dye molecules 122) with the predetermined pretilt angle variation.

In some examples, the alignment structure 204 may include a hybrid alignment polymer network. The hybrid alignment polymer network may be a hybrid interpenetrating polymer network including an organic alignment material, an inorganic alignment material, or a combination thereof. In some examples, the hybrid interpenetrating polymer network may include a combination of poly(vinyl cinnamate) (“PVCi”) used for a planar alignment of LCs and poly(dimethyl siloxane) (“PDMS”) used for a vertical alignment of LCs. Through controlling the concentration variation of the PDMS in the combination, the hybrid alignment polymer network may align the LC molecules 121 (and the dye molecules 122) with the predetermined pretilt angle variation.

As shown in FIG. 2A, at the voltage-off state, the dimming device 200 may weakly absorb an incident light 242-1, 242-4, or 242-5 having the AOI within the range of the viewing direction (or the FOV of the system 100, e.g., +30° to −30°), and may significantly absorb an obliquely incident light 242-2 or 242-3 having a large AOI (e.g., greater than or equal to 50°, 60°, or 65°, etc.). As the pretilt angle θ of the LC molecules 121 (and the dye molecules 122) are configured to vary along with the viewing directions, the dimming device 200 operating in the voltage-off state may provide a substantially same absorption (or attenuation) to incident lights having AOIs within the range of the viewing directions (or the FOV of the system 100, e.g., +30° to −30°). For example, the dimming device 200 may provide a substantially same absorption (or attenuation) to an incident light 242-1 propagating in a direction parallel to the viewing direction 150, to an incident light 242-4 propagating in a direction parallel to the viewing direction 151, and to an incident light 242-5 propagating in a direction parallel to the viewing direction 152. Thus, the dimming device 200 may provide a substantially same transmittance (e.g., 50%) to the incident light 242-1, the incident light 242-4, and the incident light 242-5 having different incidence angles with respect to the dimming device 200.

The absorption (or attenuation) provided to the incident light 242-1, 242-4, or 242-5 having the AOI within the range of the viewing directions (or the FOV of the system 100, e.g., +30° to −30°) may be independent of the polarization of the incident light 242-1, 242-2, or 242-3, as the polarization direction of the incident light 242-1, 242-2, or 242-3 may be substantially perpendicular to the absorption axes (e.g., long molecular axes) of the dye molecules 122. For example, the dimming device 200 may provide a substantially same absorption (or attenuation) to a p-polarized incident light, an s-polarized incident light, and an unpolarized incident light having an AOI within the range of the viewing directions (or the FOV of the system 100, e.g., +30° to −30°).

Further, when the AOI of the incident light at the dimming device 200 is out of the range of the viewing directions (or the FOV of the system 100, e.g., +30° to −30°), the absorption (or attenuation) of the incident light caused by the dichroic dyes 122 may gradually increase as the AOI increases, because the polarization direction of the incident light may tend to be parallel with the absorption axes of the dye molecules 122. In some examples, the dimming device 200 may be configured to significantly attenuate an obliquely incident light having a large AOI (e.g., greater than or equal to 50°, 60°, or 65°, etc.), such as an obliquely incident light 242-2 and an obliquely incident light 242-3 that are incident onto the dimming device 200 from two different sides of the dimming device 200.

As shown in FIG. 2B, when a voltage V is applied to the dimming device 200, an electric field may be generated in the dimming material layer 207. The electric field may align the LC molecules 121 in the direction of the electric field. For discussion purposes, the host LCs 121 may have a negative dielectric anisotropy (Δ_{ε}<0), the electric field may be a vertical electric field, with the electric field direction parallel with the thickness direction of the dimming device 200 or perpendicular to the surface of the dimming device 200. Under the vertical electric field, the short molecular axes of the LC molecules 121 may tend to be oriented in the thickness direction of the dimming device 200, whereas the directors (or long molecular axes) of the LC molecules 121 may tend to be oriented in the direction parallel to the surface of the dimming device 200. That is, the pretilt angles of the LC molecules 121 may tend to become substantially the same, e.g., tend to be zero. When the vertical electric field is sufficiently strong, the directors (or long molecular axes) of the LC molecules 121 may be substantially oriented in the direction parallel with the surface of the dimming device 200.

As the orientations of the dye molecules 122 change along with the orientations of the LC molecules 121, the long molecular axes of the dye molecules 122 (or the absorption axes of the positive dichroic dyes 122) may tend to be oriented in the direction parallel with the surface of the dimming device 200. The pretilt angles of the dye molecules 122 may tend to become substantially the same as the pretilt angles of the LC molecules 121. That is, the pretilt angles of the dye molecules 122 may tend to become substantially the same, e.g., tend to be zero. Accordingly, the dye molecules 122 may change from a relatively weak absorption state at the voltage-off state (shown in FIG. 2A) to a relatively strong absorption state at the voltage-on state (shown in FIG. 2B). Referring to FIGS. 2A and 2B, the dimming device 200 operating at the voltage-off state may provide a greater light absorption (or attenuation) and, thus, a lower light transmittance than at the voltage-on state. For the obliquely incident light 242-2 or 242-3 having a substantially large AOI (e.g., greater than or equal to 50°, 60°, or 65°, etc.), the dimming device 200 operating at the voltage-on state may still provide a significant absorption (or attenuation) to the incident light 242-2 or 242-3.

For discussion purposes, the operation state (e.g., when the applied voltage is less than or equal to a first threshold voltage, including zero voltage shown in FIG. 2A) where the dimming device 200 provides a maximum light transmittance to the incident light 242-1, 242-4, or 242-5 having the AOI within the range of the viewing directions may be referred to as a clear state. The operation state (e.g., when the applied voltage is greater than or equal to a second threshold voltage) where the dimming device 200 provides a minimum light transmittance to the incident light 242-1, 242-4, or 242-5 having the AOI within the range of the viewing directions may be referred to as a dark state. For example, the dimming device 200 shown in FIG. 2A may operate in the clear state, and the dimming device 200 shown in FIG. 2B may operate in the dark state.

In some examples, the dimming device 200 may also operate in an intermediate state, in addition to the clear state and the dark state. The dimming device 200 operating in the intermediate state may provide a transmittance that is greater than the minimum transmittance at the dark state, and less than the maximum transmittance at the clear state, for the incident light 242-1, 242-4, or 242-5 having the AOI within the range of the viewing directions. Through controlling the applied voltage, the dimming device 200 may be switchable between operating in the dark state, the intermediate state, and the clear state. Through controlling the transmittance of the dimming device 200, the transmittance of the see-through view observed through the dimming device 200 may be dynamically adjusted.

In some examples, an extinction ratio (that is a ratio of the maximum light transmittance over the minimum light transmittance) of the dimming device 200 may be about 10:1. That is, the light transmittance of the dimming device 200 operating at the dark state may be reduced to about 10% of the light transmittance of the dimming device 200 operating at the clear state. For example, for the incident light 242-1, 242-4, or 242-5 having the AOI within the range of the viewing directions, the maximum light transmittance of the dimming device 200 operating at the clear state may be about 50%, and the minimum light transmittance of the dimming device 200 operating at the dark state may be about 5%.

In some examples, although not shown, the host LCs 121 may have a positive dielectric anisotropy (Δ_{ε}>0), the two electrodes 209-1 and 209-2 may be disposed at the same substrate 203 to generate a horizontal electric field. The direction of the horizontal electric field may be parallel with the surface of the dimming device 200. Under the horizontal electric field, the directors (or long molecular axes) of the LC molecules 121 and the long molecular axes of the dye molecules 122 may tend to be oriented in the direction parallel with the surface of the dimming device 200. Accordingly, the dye molecules 122 may change to a relatively strong absorption state at the voltage-on state from a relatively weak absorption state at the voltage-off state for the substantially normally incident ambient light 242-1.

FIG. 2C illustrates an x-z sectional view of a dimming device 250, according to one or more examples of the present disclosure. The dimming device 250 may be an example of the dimming device 120 shown in FIGS. 1A and 1B. The dimming device 250 shown in FIG. 2C may be a passive dimming device. The dimming device 120 shown in FIG. 2C may include elements, structures, and/or functions that are the same as or similar to those included in the dimming device 200 shown in FIGS. 2A and 2B. Descriptions of the same or similar elements, structures, and/or functions can refer to the above descriptions rendered in connection with FIGS. 2A and 2B.

As shown in FIG. 2C, the dimming device 250 may include two substrates 203, two alignment structures 204, and a dimming material layer 257 disposed between the two alignment structures 204. The dimming device 250 may not include electrodes. In some examples, one of the substrates 203 may be the light guide 110 shown in FIG. 1A. In some examples, one of the substrates 203, e.g., the upper substrate 203 may have a curved shape. For example, when the first dimming device 120-1 shown in FIG. 1A is the dimming device 250, the upper substrate 203 of the dimming device 250 may be the light guide 110 shown in FIG. 1A, and the lower substrate 203 of the dimming device 250 may function as a prescription lens having a curved shape.

In some examples, the dimming material layer 257 may include passive LCs 121, e.g., reactive mesogens. The LC molecules 121 and the dye molecules 122 in the dimming material layer 257 may be configured with a predetermined pretilt angle variation from the center 205 to the two peripheries 210, similar to that shown in FIG. 2A. The passive dimming device 250 may be configured to operate in the clear state, similar to that shown in FIG. 2A. For example, the dimming device 250 may weakly absorb the incident lights 242-1, 242-4, and 242-5 having the AOI within the range of the viewing directions (or the FOV of the system 100, e.g., +30° to −30°), and may significantly absorb the obliquely incident lights 242-2 and 242-3 having a large AOI (e.g., greater than or equal to 50°, 60°, or 65°, etc.). The dimming device 250 may provide a maximum light transmittance (e.g., 50%) to the incident lights 242-1, 242-4, and 242-5 having the AOI within the range of the viewing directions. The dimming device 250 may provide a substantially same transmittance (e.g., 50%) to the incident light 242-1, the incident light 242-4, and the incident light 242-5 having different incidence angles.

Referring back to FIGS. 1A and 1B, for discussion purposes, FIGS. 1A and 1B show that the second dimming device 120-2 is an active dimming device (e.g., the dimming device 200 shown in FIGS. 2A and 2B), and the first dimming device 120-1 is a passive dimming device (e.g., the dimming device 250 shown in FIG. 2C). FIG. 1A shows the second dimming device 120-2 operating in the clear state, and FIG. 1B shows the second dimming device 120-2 operating in the dark state. The first dimming device 120-1 (that may be a passive dimming device) may be configured to operate in the clear state. For discussion purposes, the operation state of the system 100 having the second dimming device 120-2 operating in the clear state may also be referred to as an “OFF” state, and the operation state of the system 100 having the second dimming device 120-2 operating in the dark state may also be referred to as an “ON” state.

As shown in FIG. 1A, the controller 115 may control the second dimming device 120-2 to operate in the clear state, and control the light source assembly 105 to operate in an off-state. The system 100 may operate in the “OFF” state when the light source assembly 105 operates in an off-state. For example, the controller 115 may turn off the display element (not shown) included in the light source assembly 105. The light source assembly 105 may include an optical shutter disposed between the display element and the collimating lens, and the optical shutter may be controlled by the controller 115 to substantially block the image light output from the display element from being incident onto the collimating lens. In some examples, the light source assembly 105 may include an optical shutter disposed between the collimating lens and the light guide 110, and the optical shutter may be controlled by the controller 115 to substantially block the image light 130 output from the collimating lens from being incident onto the light guide 110. Thus, the light guide 110 may not receive the image light 130.

The second dimming device 120-2 may receive ambient lights 142-1 and 142-2 (collectively referred to as ambient light 142) coming from the real-world environment located at the second side 110-2 of the light guide 110. For example, the ambient light 142-2 may come from the sun 170. The first dimming device 120-1 may receive an ambient light 142-3 coming from the real-world environment located at the first side 110-1 of the light guide 110. For example, the ambient light 142-3 may come from a lamp 175. The second dimming device 120-2 operating in the clear state may provide a maximum light transmittance (e.g., 50%) to an ambient light 142 (e.g., 142-1) having an AOI within the range of the viewing directions (or the FOV of the system 100, e.g., +30° to −30°). For discussion purposes, FIG. 1A merely shows the ambient light 142-1 that is substantially normally incident onto the second dimming device 120-2. The second dimming device 120-2 may provide a substantially same light transmittance (e.g., 50%) to the ambient light 142-1 independent of the polarization state of the ambient light 142-1. Further, when the AOI of the ambient light 142 at the second dimming device 120-2 is out of the range of the viewing directions (or the FOV of the system 100, e.g., +30° to −30°), the absorption (or attenuation) provided by the second dimming device 120-2 may gradually increase as the AOI increases. In some examples, the second dimming device 120-2 may be configured to significantly attenuate an obliquely incident ambient light 142-2 having a large AOI (e.g., greater than or equal to 50°, 60°, or 65°, etc.).

Thus, the rainbow effect in the see-through view caused by the dispersion of the ambient light 142-2 may be significantly reduced, while the brightness of the desired see-through image may be slightly reduced. In addition, as the orientation (or pretilt angles θ) of the LC molecules 121 and the dye molecules 122 in the second dimming device 120-2 are configured to vary along with the viewing direction of the eye 160 looking through the system 100, the eye 160 positioned within the eye-box region 159 may perceive a substantially same brightness of the see-through view, as the viewing direction changes within the range of the viewing directions (or the FOV of the system 100, e.g., +30° to −30°).

The ambient light 142-1 transmitted through the second dimming device 120-2 and the light guide 110 may be incident onto the first dimming device 120-1. The first dimming device 120-1 (that is a passive dimming device configured to operate in the clear state) may function similarly to the second dimming device 120-2 operating in the clear state. Thus, the first dimming device 120-1 may provide a maximum light transmittance (e.g., 50%) to the ambient light 142 (e.g., 142-1) having the AOI within the range of the viewing directions (or the FOV of the system 100, e.g., +30° to −30°). The first dimming device 120-1 may also significantly attenuate the obliquely incident ambient light 142-3 having a large AOI (e.g., greater than or equal to 50°, 60°, or 65°, etc.).

Thus, the rainbow effect in the see-through view caused by the dispersion of the ambient light 142-2 and 142-3 may be significantly reduced, while the brightness of the desired see-through image may be slightly reduced. In addition, as the orientation (or pretilt angles θ) of the LC molecules 121 and the dye molecules 122 in the first dimming device 120-1 are configured to vary along with the viewing direction of the eye 160 looking through the system 100, the eye 160 positioned within the eye-box region 159 may perceive a substantially same brightness of the see-through view, as the viewing direction changes within the range of the viewing directions (or the FOV of the system 100, e.g., +30° to −30°).

Overall, the first dimming device 120-1 may significantly reduce the rainbow effect caused by the dispersion of the ambient light 142-3 coming from the first side 110-1 of the light guide 110, and the second dimming device 120-2 may significantly reduce the rainbow effect caused by the dispersion of the ambient light 142-2 coming from the second side 110-2 of the light guide 110. Benefiting from the specifically configured pretilt angle variation in the first dimming device 120-1 and the second dimming device 120-2, the eye 160 positioned within the eye-box region 159 may perceive a substantially same (or uniform) brightness of the see-through view, as the viewing direction changes within the range of the viewing directions (or the FOV of the system 100, e.g., +30° to −30°). That is, the system 100 may provide an enhanced angular brightness uniformity of the see-through view over the FOV of the system 100.

As shown in FIG. 1B, the controller 115 may control the second dimming device 120-2 to operate in the dark state, and control the light source assembly 105 to operate in an on-state. The system 100 may operate in the “ON” state when the light source assembly 105 operates in an on-state. For example, the controller 115 may turn on the display element (not shown) included in the light source assembly 105. In some examples, the controller 115 may control the optical shutter disposed between the display element and the collimating lens or disposed between the collimating lens and the light guide 110 to transmit the image light 130 toward the light guide 110. Thus, the in-coupler 135 may receive the image light 130 from the light source assembly 105, and couple the image light 130 into the light guide 110 as the in-coupled image light 131. The out-coupler 145 may couple the in-coupled image light 131 out of the light guide 110 as the output image lights 132.

The output image lights 132 may be incident onto the first dimming device 120-1. As the AOIs of the output image lights 132 at the first dimming device 120-1 is within the range of the viewing directions (or the FOV of the system 100, e.g., +30° to −30°), the first dimming device 120-1 may be configured to provide a maximum light transmittance (e.g., 50%) to the output image lights 132. The second dimming device 120-2 operating in the dark state may provide a minimum light transmittance (e.g., 5%) to the ambient light 142 (e.g., 142-1) having the AOI within the range of the viewing directions. Thus, the eye 160 located within the eye-box region 159 may substantially not perceive the ambient light 142-1. That is, the ambient light 142-1, which would otherwise be mixed with the output image light 132, may be substantially blocked by the second dimming device 120-2. Thus, the contrast ratio of the virtual image (formed by the output image light 132) perceived by the eye 160 located within the eye-box region 159 may be increased.

In addition, benefiting from the specifically configured pretilt angle variation in the first dimming device 120-1, the eye 160 positioned within the eye-box region 159 may perceive a substantially same (or uniform) brightness of the virtual image (formed by the output image lights 132), as the viewing direction changes within the range of the viewing directions (or the FOV of the system 100, e.g., +30° to −30°). That is, the system 100 may enhance the angular brightness uniformity of the virtual image formed by the output image lights 132 over the FOV of the system 100.

Further, the second dimming device 120-2 operating in the dark state may also significantly attenuate the obliquely incident ambient light 142-2 having the large AOI (e.g., greater than or equal to 50°, 60°, or 65°, etc.). Thus, the rainbow effect caused by the dispersion of the ambient light 142-2 may be significantly reduced. The first dimming device 120-1 may significantly attenuate the obliquely incident ambient light 142-3 having the large AOI (e.g., greater than or equal to 50°, 60°, or 65°, etc.). Thus, the rainbow effect caused by the dispersion of the ambient light 142-3 may be significantly reduced.

As the ambient lights 142 can be significantly attenuated by the first dimming device 120-1 and the second dimming device 120-2, a display element (e.g., micro-projector) may be implemented in the system 100. For example, a micro-OLED (or uOLED) display may provide a high resolution of over 2000 pixels per inch, but a low brightness due to the organic emitting materials. The first dimming device 120-1 and the second dimming device 120-2 in the disclosed system 100 may be configured to significantly attenuate the ambient lights 142 and, thus, the contrast ratio of the virtual image (generated by the uOLED display) perceived by the eye 160 may be significantly increased. Accordingly, the eye 160 may perceive a virtual image having a high resolution of over 1000 pixels per inch and an enhanced contrast ratio.

Referring to FIGS. 1A and 1B, during an operation of the system 100, one or more (e.g., each) of display frames may include two subframes, a first subframe and a second subframe. The first subframe and second subframe may also be referred to as a real-world subframe and a virtual-world subframe, respectively. FIG. 1A shows the operation of the system 100 during the first subframe, and FIG. 1B shows the operation of the system 100 during the second subframe. The switching of the second dimming device 120-2 may be synchronized with the switching of the display element (or the light source assembly 105).

For example, during the first subframe, the controller 115 may control the second dimming device 120-2 to operate in the clear state, and control the light source assembly 105 to operate in an off-state. Accordingly, the system 100 may operate in the “OFF” state during the first subframe, substantially transmitting the ambient light 142-1 toward the eye-box region 159. During the second subframe, the controller 115 may control the second dimming device 120-2 to operate in the dark state, and control the light source assembly 105 to operate in an on-state. The system 100 may operate in the “ON” state during the second subframe, providing a strong dimming effect to substantially block the ambient light 142-1 from being transmitted toward the eye-box region 159. Thus, during the display frame, the eye 160 located within the eye-box region 159 may perceive a superimposed image of a real-world image formed by the ambient light 142-1 and a virtual image formed by the output image lights 132. The superimposed image may have an increased image quality, as the system 100 reduces the rainbow effect, enhances the contrast ratio, and enhances the brightness uniformity over the FOV.

In some examples, the first subframe may have a longer duration than the second subframe, e.g., the first subframe may last for about 90% to 99% of the time duration of the display frame. The first subframe and the second first subframe may be switched at a rate that exceeds a flicker fusion threshold of the eye 160. For example, the frame rate of the display element may be at least 60 Hz according to the frame rate of the human vision. The display element included in the light source assembly 105 may be a high-speed projector, which may be configured to be switched off during the first subframe and switched on during the second subframe. The high-speed projector may have a sufficiently short switching time, such that the first subframe and the second first subframe may be presented at a rate that exceeds the flicker fusion threshold of the of the eye 160.

In some examples, although not shown, the controller 115 may control the second dimming device 120-2 to operate in the intermediate state. Although not shown, the second dimming device 120-2 may be a passive dimming device (e.g., the dimming device 250 shown in FIG. 2C), and the first dimming device 120-1 may be an active dimming device (e.g., the dimming device 200 shown in FIGS. 2A and 2B). Although not shown, in some examples, both the first dimming device 120-1 and the second dimming device 120-2 may be active dimming devices (e.g., the dimming device 200 shown in FIGS. 2A and 2B). In some examples, although not shown, both the first dimming device 120-1 and the second dimming device 120-2 may be passive dimming devices (e.g., the dimming device 250 shown in FIG. 2C).

FIG. 1C illustrates an x-z sectional view of a display system 180 configured to reduce a rainbow effect and increase a contrast ratio, according to one or more examples of the present disclosure. The display system 180 may include elements, structures, and/or functions that are the same as or similar to those included in the display system 100 shown in FIGS. 1A and 1B. Descriptions of the same or similar elements, structures, and/or functions can refer to the above descriptions rendered in connection with FIGS. 1A and 1B. The display system 180 may be a light guide display system. The display system 180 may include a single dimming device disposed at a side of the light guide 110. For discussion purposes, FIG. 1C shows that the display system 180 includes a single dimming device, i.e., the second dimming device 120-2 disposed at the second side 110-2 of the light guide 110. In some examples, although not shown, the display system 180 may include a single dimming device, i.e., the first dimming device 120-1 disposed at the first side 110-1 of the light guide 110.

For discussion purposes, FIGS. 1A-1C show that the dimming device 120 substantially covers substantially an entire surface (e.g., substantially the entire first surface 110-1 or substantially the entire second surface 110-2) of the light guide 110. In some examples, the dimming device 120 may cover a portion of the surface of the light guide 110, rather than substantially the entire surface (e.g., entire first surface 110-1 or entire second surface 110-2) of the light guide 110. In some examples, the dimming device 120 may cover a portion of the light guide 110 corresponding to the output coupler 145 and/or the folding element (not shown). For example, the size of the dimming device 120 may be equal to the size of the output coupler 145 and/or the size of the folding element (not shown).

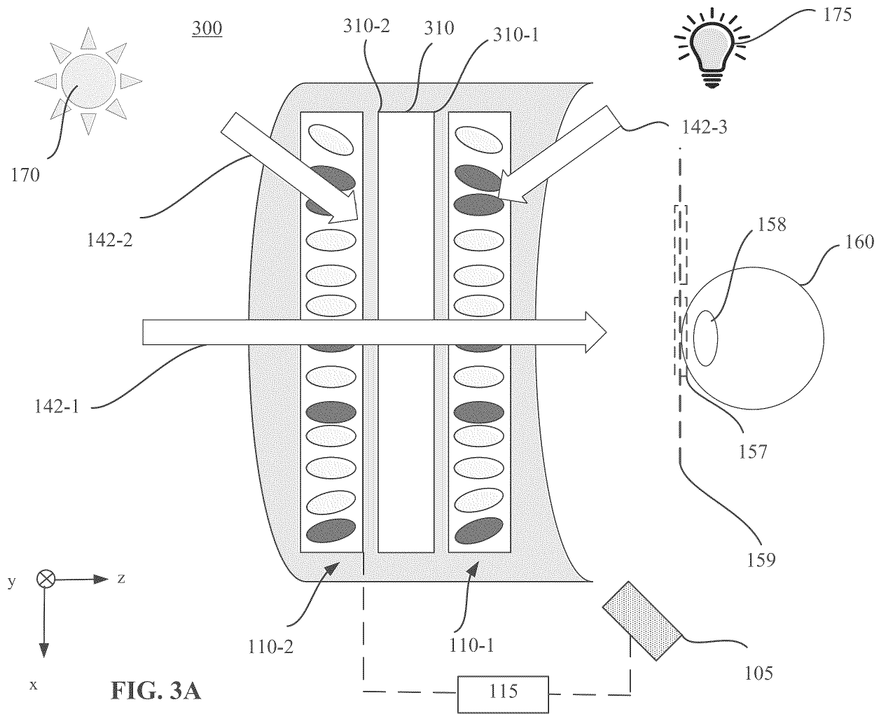

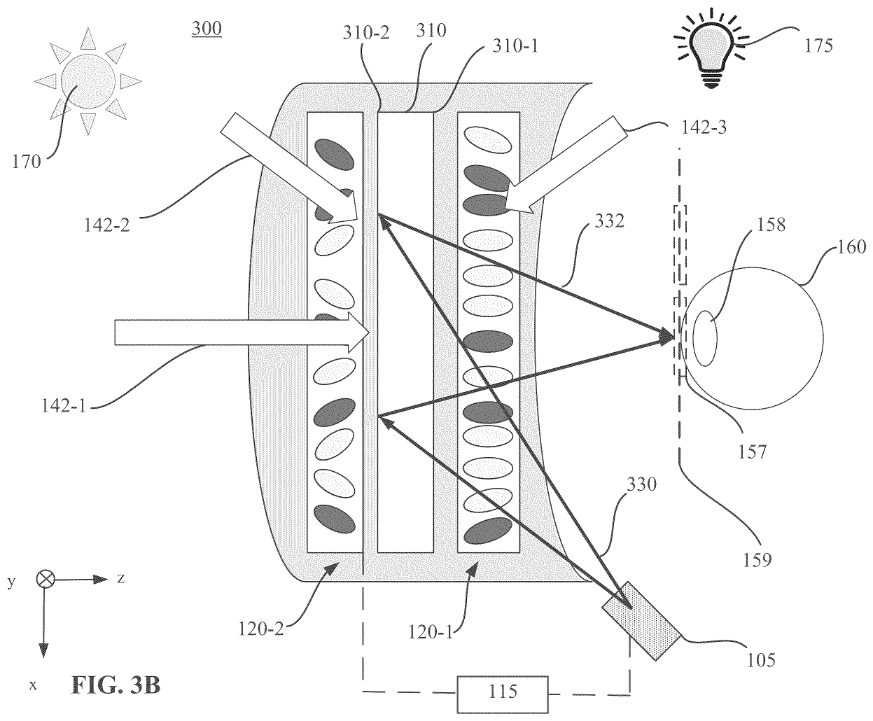

FIGS. 3A and 3B illustrate x-z sectional views of a display system 300 configured to reduce a rainbow effect and increase a contrast ratio, according to one or more examples of the present disclosure. The display system 300 may include elements, structures, and/or functions that are the same as or similar to those included in the display system 100 shown in FIGS. 1A and 1B, or the display system 180 shown in FIG. 1C. Descriptions of the same or similar elements, structures, and/or functions can refer to the above descriptions rendered in connection with FIGS. 1A and 1B, or FIG. 1C.

As shown in FIGS. 3A and 3B, the display system 300 may include the light source assembly 105, an image combiner 310, the controller 115, the first dimming device 120-1, and the second dimming device 120-2. The image combiner 310 may be an HOE image combiner 310, and the display system 300 may be an HOE based display system. The light source assembly 105 may include a display element configured to provide an off-axis projection with respective to the image combiner 310. For example, an image light 330 output from the light source assembly 105 may be an off-axis image light with respective to the image combiner 310. In some examples, the image combiner 310 may function as an off-axis reflective lens configured to focus the off-axis image light 330 to one or more exit pupils 157 within the eye-box region 159. FIG. 3A shows that the system 300 operates in an “OFF” state, similar to that shown in FIG. 1A, and FIG. 3B shows that the system 300 operates in an “ON” state, similar to that shown in FIG. 1B. The system 300 may reduce the rainbow effect, increase the contrast ratio, and enhance the brightness uniformity over the FOV of the system 300.

The configuration of the display system 100 shown in FIGS. 1A and 1B, the display system 180 shown in FIG. 1C, or the display system 300 shown in FIGS. 3A and 3B are used as example display systems to illustrate and explain the operation principles of the disclosed system and method for reducing the rainbow effect, increasing the contrast ratio, and enhancing the brightness uniformity over the FOV. The operation principles of the disclosed system and method that use the disclosed dimming devices to reduce the rainbow effect, increase the contrast ratio, and enhance the brightness uniformity over the FOV may be applicable to any suitable display systems, other than the display systems disclosed herein.

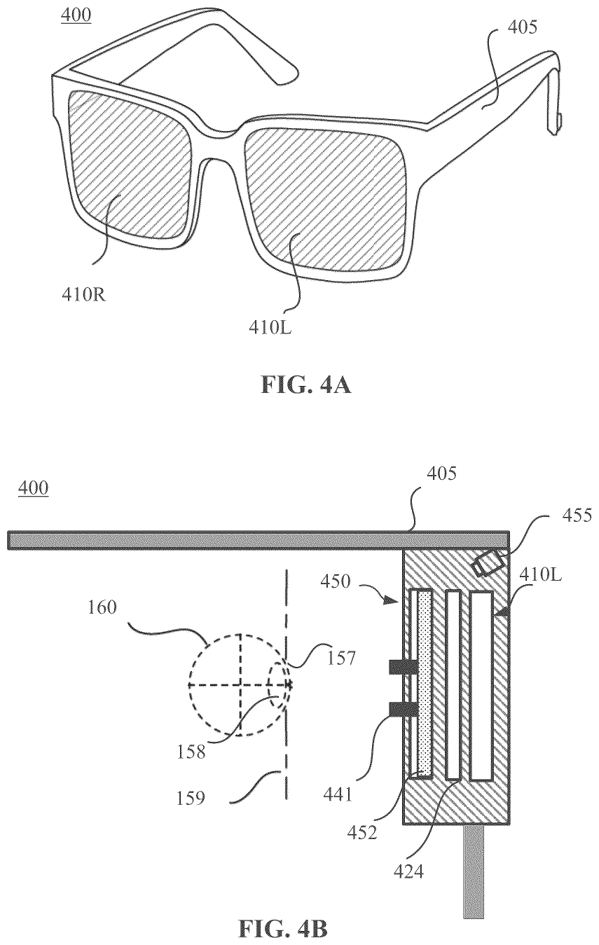

FIG. 4A illustrates a schematic diagram of an artificial reality device 400 according to one or more examples of the present disclosure. The artificial reality device 400 may be smart glasses, or a near-eye display (“NED”). The artificial reality device 400 may be in the form of eyeglasses, goggles, a helmet, a visor, or some other type of eyewear. The artificial reality device 400 may be configured to be worn on a head of a user (e.g., by having the form of spectacles or eyeglasses, as shown in FIG. 4A), or to be included as part of a helmet that is worn by the user. In some examples, the artificial reality device 400 may be configured for placement in proximity to an eye or eyes of the user at a fixed location in front of the eye(s), without being mounted to the head of the user. In some examples, the artificial reality device 400 may be in a form of eyeglasses which provide vision correction to a user's eyesight. In some examples, the artificial reality device 400 may be in a form of sunglasses which protect the eyes of the user from the bright sunlight, or in a form of safety glasses which protect the eyes of the user.

For discussion purposes, FIG. 4A shows that the artificial reality device 400 includes a frame 405 configured to mount to a user's head, and left-eye and right-eye display systems 410L and 410R mounted to the frame 405. FIG. 4B is a cross-sectional view of half of the artificial reality device 400 shown in FIG. 4A according to one or more examples of the present disclosure. For discussion purposes, FIG. 4B shows the cross-sectional view associated with the left-eye display system 410L. The frame 405 is merely an example structure to which various components of the artificial reality device 400 may be mounted. Other suitable type of fixtures may be used in place of or in combination with the frame 405.

One or more (e.g., each) of the left-eye and right-eye display systems 410L and 410R may include a display system configured to generate an image light representing a virtual image, and direct the image light toward the eye-box region 159, such as the display system 100 shown in FIGS. 1A and 1B, the display system 180 shown in FIG. 1C, or the display system 300 shown in FIGS. 3A and 3B. The left-eye and right-eye display systems 410L and 410R may reduce the rainbow effect, increase the contrast ratio, and enhance the brightness uniformity over the FOV. Thus, the image quality provided by the left-eye and right-eye display systems 410L and 410R may be increased.

The artificial reality device 400 may also include a viewing optics system 424 disposed between the left-eye display system 410L or right-eye display system 410R and the eye-box region 159. The viewing optics system 424 may be configured to perform a suitable optical adjustment of the image light output from the left-eye display system 410L or right-eye display system 410R, e.g., correct aberrations in the image light, adjust a position of the focal point of the image light in the eye-box region 159, adjust a propagation direction of the image light toward the eye-box region 159, etc.

As shown in FIG. 4B, the artificial reality device 400 may also include an object tracking system 450 (e.g., eye tracking system and/or face tracking system). The object tracking system 450 may include an IR light source 451 configured to illuminate the eye 160 and/or the face, a light deflecting element 452 configured to deflect the IR light reflected by the eye 160, and an optical sensor 455 configured to receive the IR light deflected by the light deflecting element 452 and generate a tracking signal. A controller (e.g., one similar to controller 115 shown in FIG. 1A) may be included in the artificial reality device 400.

According to some aspects of the present disclosure, a system is provided. The system may include a display element configured to output an image light; an image combiner configured to guide the image light toward an eye-box region of the system; and a dimming device disposed at a side of the image combiner. The dimming device may include a dimming material layer including a mixture of liquid crystal (“LC”) molecules and dye molecules. Pretilt angles of the LC molecules and the dye molecules may be configured with a predetermined variation in at least two opposite in-plane directions from a center to two opposite peripheries of the dimming material layer. In some examples, the pretilt angles of the LC molecules and the dye molecules may be configured to gradually decrease in the at least two opposite in-plane directions from the center to the two opposite peripheries of the dimming material layer. In some examples, the two opposite peripheries of the dimming material layer may include a first periphery and a second periphery, and orientations of the LC molecules and the dye molecules may be configured to rotate in a clockwise direction from the center to the first periphery and rotate in a counter-clockwise direction from the center to the second periphery.

According to some aspects of the present disclosure, the dimming device may be configured to provide a higher light transmittance to a first ambient light from a real-world environment and having a first angle of incidence (“AOI”) within a field of view (“FOV”) of the system than a second ambient light having a second AOI outside of the FOV. The dimming device may be configured to substantially block the second ambient light when the second AOI is greater than 60°. The dimming device may be configured to provide a uniform transmittance to the first ambient light when the first AOI changes within the FOV.

According to some aspects of the present disclosure, the image combiner may include a first side facing the eye-box region and an opposing second side, and the dimming device may be disposed at the second side of the image combiner. The dimming device may be configured to be switchable between operating in a first state where the pretilt angles of the LC molecules and the dye molecules are configured with the predetermined variation, and operating in a second state where the pretilt angles of the LC molecules and the dye molecules are substantially the same. The dimming device operating in the first state may be configured to provide a higher light transmittance to an ambient light from a real-world environment and having an AOI within an FOV of the system than the dimming device operating in the second state. The dimming device operating in the first state may be configured to substantially transmit the ambient light having an AOI within an FOV of the system, and the dimming device operating in the second state may be configured to substantially block the ambient light having the AOI within the FOV of the system. The device may include a controller configured to: control, during a first time period, the display element to not output the image light, and the dimming device to operate in the first state; and control, during a second time period, the display element to output the image light, and the dimming device to operate in the second state.

According to some aspects of the present disclosure, the dimming device may be a first dimming device, the dimming material layer may be a first dimming material layer, the pretilt angles may be first pretilt angles, the LC molecules may be first LC molecules, the dye molecules may be first dye molecules, and the system may further include a second dimming device disposed at the first side of the image combiner. The second dimming device may include a second dimming material layer having a mixture of second LC molecules and second dye molecules. Second pretilt angles of the second LC molecules and the second dye molecules may be configured with the predetermined variation in at least two opposite in-plane directions from a center to two opposite peripheries of the second dimming material layer. The second dimming device may be configured to substantially transmit the image light received from the image combiner toward the eye-box region. In some examples, the second dimming device may be configured to substantially block an ambient light from a real-world environment and having an AOI outside of an FOV of the system and greater than 60°.

According to some aspects of the present disclosure, the image combiner may be a light guide, and the system may further include a plurality of couplers configured to couple the image light into the light guide and out of the light guide toward the eye-box region. The couplers may be arranged at a surface of the light guide or embedded inside the light guide. The image combiner may include a holographic optical element (“HOE”) configured to focus the image light received from the display element toward the eye-box region. An absorption axis of the dye molecules may be along long molecular axes of the dye molecules. In some examples, the dimming device may further include an alignment layer coupled with the dimming material layer, the alignment layer being configured to align the LC molecules and the dye molecules in the dimming material layer to have the predetermined variation of the pretilt angles. The alignment layer may include a mixture of homogeneous alignment structures and homeotropic alignment structures, and a ratio of the homeotropic alignment structures over the homogeneous alignment structures may be configured with a predetermined variation in at least two opposite in-plane directions from a center to two opposite peripheries of the alignment layer.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Embodiments of the present disclosure may also relate to an apparatus for performing the operations herein. This apparatus may be specially constructed for the specific purposes, and/or it may include a general-purpose computing device or specifically-programmed computer device selectively activated or reconfigured by a computer program stored in the computing device. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A system, comprising:
a display element configured to output an image light;
an image combiner configured to guide the image light toward an eye-box region of the system; and
a dimming device disposed at a side of the image combiner,
wherein the dimming device includes a dimming material layer including a mixture of liquid crystal (“LC”) molecules and dye molecules, and
wherein pretilt angles of the LC molecules and the dye molecules are configured with a predetermined variation in at least two opposite in-plane directions from a center to two opposite peripheries of the dimming material layer.

2. The system of claim 1, wherein the pretilt angles of the LC molecules and the dye molecules are configured to gradually decrease in the at least two opposite in-plane directions from the center to the two opposite peripheries of the dimming material layer.

3. The system of claim 1, wherein
the two opposite peripheries of the dimming material layer include a first periphery and a second periphery, and
orientations of the LC molecules and the dye molecules are configured to rotate in a clockwise direction from the center to the first periphery and rotate in a counter-clockwise direction from the center to the second periphery.

4. The system of claim 1, wherein the dimming device is configured to provide a higher light transmittance to a first ambient light from a real-world environment and having a first angle of incidence (“AOI”) within a field of view (“FOV”) of the system than to a second ambient light having a second AOI outside of the FOV.

5. The system of claim 4, wherein the dimming device is configured to substantially block the second ambient light when the second AOI is greater than 60°.

6. The system of claim 4, wherein the dimming device is configured to provide a uniform transmittance to the first ambient light at different first angles of incidence within the FOV.

7. The system of claim 1, wherein the image combiner has a first side facing the eye-box region and an opposing second side, and the dimming device is disposed at the second side of the image combiner.

8. The system of claim 7, wherein the dimming device is switchable between operating in a first state where the pretilt angles of the LC molecules and the dye molecules are configured with the predetermined variation, and operating in a second state where the pretilt angles of the LC molecules and the dye molecules are substantially the same.

9. The system of claim 8, wherein the dimming device operating in the first state is configured to provide a higher light transmittance to an ambient light from a real-world environment and having an angle of incidence within a field of view of the system than the dimming device operating in the second state.

10. The system of claim 8, wherein the dimming device operating in the first state is configured to substantially transmit the ambient light having an angle of incidence within a field of view of the system, and the dimming device operating in the second state is configured to substantially block the ambient light having the angle of incidence within the field of view of the system.

11. The system of claim 8, further comprising a controller configured to:
control, during a first time period, the display element to not output the image light, and the dimming device to operate in the first state; and
control, during a second time period, the display element to output the image light, and the dimming device to operate in the second state.

12. The system of claim 7, wherein the dimming device is a first dimming device, the dimming material layer is a first dimming material layer, the pretilt angles are first pretilt angles, the LC molecules are first LC molecules, the dye molecules are first dye molecules, and the system further comprises a second dimming device disposed at the first side of the image combiner,
wherein the second dimming device includes a second dimming material layer having a mixture of second LC molecules and second dye molecules, and
wherein second pretilt angles of the second LC molecules and the second dye molecules are configured with the predetermined variation in at least two opposite in-plane directions from a center to two opposite peripheries of the second dimming material layer.

13. The system of claim 12, wherein the second dimming device is configured to substantially transmit the image light received from the image combiner toward the eye-box region.

14. The system of claim 12, wherein the second dimming device is configured to substantially block an ambient light from a real-world environment and having an angle of incidence outside of a field of view of the system and greater than 60°.

15. The system of claim 1, wherein the image combiner is a light guide, and the system further comprises a plurality of couplers configured to couple the image light into the light guide and out of the light guide toward the eye-box region.

16. The system of claim 15, wherein the couplers are arranged at a surface of the light guide or embedded inside the light guide.

17. The system of claim 1, wherein the image combiner includes a holographic optical element configured to focus the image light received from the display element toward the eye-box region.

18. The system of claim 1, wherein an absorption axis of the dye molecules is along long molecular axes of the dye molecules.

19. The system of claim 1, wherein the dimming device further comprises an alignment layer coupled with the dimming material layer, the alignment layer being configured to align the LC molecules and the dye molecules in the dimming material layer to have the predetermined variation of the pretilt angles.

20. The system of claim 19, wherein the alignment layer includes a mixture of homogeneous alignment structures and homeotropic alignment structures, and a ratio of the homeotropic alignment structures over the homogeneous alignment structures is configured with a predetermined variation in at least two opposite in-plane directions from a center to two opposite peripheries of the alignment layer.
